(19) United States
(12) Patent Application Publication
(10) Pub. No.: US 2026/0029531 A1
(43) Pub. Date: Jan. 29, 2026

(54) DUAL SELF-MIXING INTERFEROMETRY DEVICE AND METHOD

(71) Applicant: ams-OSRAM Asia Pacific Pte. Ltd., Singapore (SG)

(72) Inventors: Laurent NEVOU, Wadenswil (CH); Markus DANTLER, Thalwil (CH); Svenja MAUTHE, Altendorf (CH); Jens GEIGER, Thalwil (CH)

(21) Appl. No.: 18/998,129

(22) PCT Filed: Jul. 19, 2023
(86) PCT No.: PCT/EP2023/070032

§ 371 Date: Jan. 24, 2025

(30) Foreign Application Priority Data
Jul. 25, 2022 (DE) 10 2022 118 565.6

(51) Int. Cl. G01S 17/58; G01S 7/481; G01S 7/4915

(52) U.S. Cl. CPC G01S 17/58; G01S 7/4815; G01S 7/4816; G01S 7/4915

(57) ABSTRACT

A detection device includes a first electromagnetic radiation device, configured to emit first electromagnetic radiation at a first time period, receive a reflection of the first electromagnetic radiation emitted at the first time period from a target, and modulate first electromagnetic radiation emitted at a second time period by the received reflection of the first electromagnetic radiation; a second electromagnetic radiation device, configured to emit second electromagnetic radiation at the first time period, receive a reflection of the second electromagnetic radiation emitted at the first time period from the target, and modulate second electromagnetic radiation emitted at a second time period by the received reflection of the second electromagnetic radiation; and a processor, configured to determine a rotational movement of the target based on the modulated first electromagnetic radiation, the modulated second electromagnetic radiation, and a predetermined distance between the first electromagnetic radiation device and the second electromagnetic radiation device.

### CROSS-REFERENCE TO RELATED APPLICATIONS

This application claims priority to German Patent Application 10 2022 118 565.6, filed on Jul. 25, 2022, the entire contents of which are hereby incorporated herein by reference.

### TECHNICAL FIELD

Various aspects of this disclosure generally relate to self-mixing interferometry (SMI) for a rotational device.

### BACKGROUND

SMI is a technique in which an electromagnetic radiation source (e.g. configured as a laser) directs electromagnetic radiation onto a moving (e.g. rotating) target, and at least a portion of this electromagnetic radiation is then reflected back to the source. Assuming that the target surface is non-normal to the path of the electromagnetic radiation, the reflected electromagnetic radiation f_{D} (or Doppler frequency) undergoes a Doppler shift that depends on the instantaneous rotational velocity of the portion of the rotating target onto which the electromagnetic radiation is directed, and an angle of incidence between the electromagnetic radiation and the rotating target. Some of this Doppler shifted, reflected electromagnetic radiation f_{D} is received at the source (e.g. in the laser cavity) and is coherently added to (e.g. modulates) newly generated electromagnetic radiation. This coherent addition may be detected, as with a photodiode (power readout), or may be measured as a change in the voltage junction of the laser while driven with a current source. The resulting signal (e.g. power or voltage readout) is referred to herein as an SMI signal, which reflects the laser output as modulated by f_{D}. The SMI signal may include modulations in both amplitude and frequency compared to the driving signal (e.g. the unmodulated output). Various techniques exist to recover the velocity and/or the direction of the target's movement from this SMI signal. Once such technique involves transforming the SMI signal from the time domain to the frequency domain, such as with a Fast Fourier Transform, and deriving the rotational velocity from resulting frequency information. Although capable of highly accurate results, this method is computationally demanding and thus may be undesirable in many implementations. Another technique involves counting the crests (e.g. the “fringes”) of the time-domain SMI signal. The number of fringes in a given duration can be used to determine the frequency of the SMI signal, which can then be used to determine a rotational movement of the target. Furthermore, the fringes will slant left or right within the time domain, which provides information about the direction of rotation.

Conventional SMI devices typically rely on a single laser to generate and direct light toward the rotating target. At least two problems are associated with this conventional technique.

The first problem related is that of dark speckle. Any non-smooth target-surface will result in speckle (e.g. dark speckle and bright speckle), which modulates the amplitude of the resulting SMI signal in the time-domain. That is, dark speckle will reduce the amplitude, and bright speckle will increase the amplitude of the received SMI signal. Dark speckle's reduction of amplitude may reduce the amplitude of the SMI such that it cannot be detected, that the amplitude falls beneath certain nominal thresholds, or otherwise so as to result in errors in determining the target velocity from the SMI signal. This may be particularly true when using the fringe-counting method.

The second problem is that of calibration. Conventional SMI sensors require significant calibration to have meaningful or standardized readouts related to a position of a rotational device. That is, the SMI signal can recover an instantaneous velocity v of a particular portion of a rotating target; however, the instantaneous velocity v of this particular portion may not be of interest. Rather, it may be desirable to determine the instantaneous velocity of another portion of the rotation target or the angular velocity of the rotating target. The angular velocity ω may be determined by

$$\frac{v}{R} = ω ,$$

where R in this context is the distance between the axis of rotation of the target and the point onto which the electromagnetic radiation is directed. This radius R may be subject to significant manufacturing tolerances, which may result in unacceptable error without calibration. Such calibration procedures increase manufacturing difficulties and costs.

A dual SMI device is disclosed in US 2019/0317454 A1, which includes, in a particular embodiment, two lasers and two corresponding signals for SMI detection.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts an SMI detection device;

FIG. 2 depicts the avoidance of signal loss due to dark speckle using multiple SMI signals;

FIG. 3 depicts a frequency shift according to an aspect of the disclosure;

FIG. 4 depicts rotational frequency and light of an SMI signal;

FIG. 5 depicts a configuration of the electromagnetic radiation devices relative to the axis of rotation of a disk;

FIG. 6 depicts a configuration of the electromagnetic radiation devices relative to the axis of rotation of the disk;

FIG. 7 depicts a configuration of the electromagnetic radiation devices relative to a rotating shaft according to a third aspect of the disclosure;

FIG. 8 depicts a configuration of the electromagnetic radiation devices relative to a rotating shaft according to a fourth aspect of the disclosure;

FIG. 9 depicts a package assembly according to an aspect of the disclosure;

FIG. 10 depicts a package assembly according to another aspect of the disclosure; and

FIG. 11 depicts a package assembly according to yet another aspect of the disclosure.

### DESCRIPTION

The following detailed description refers to the accompanying drawings that

show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

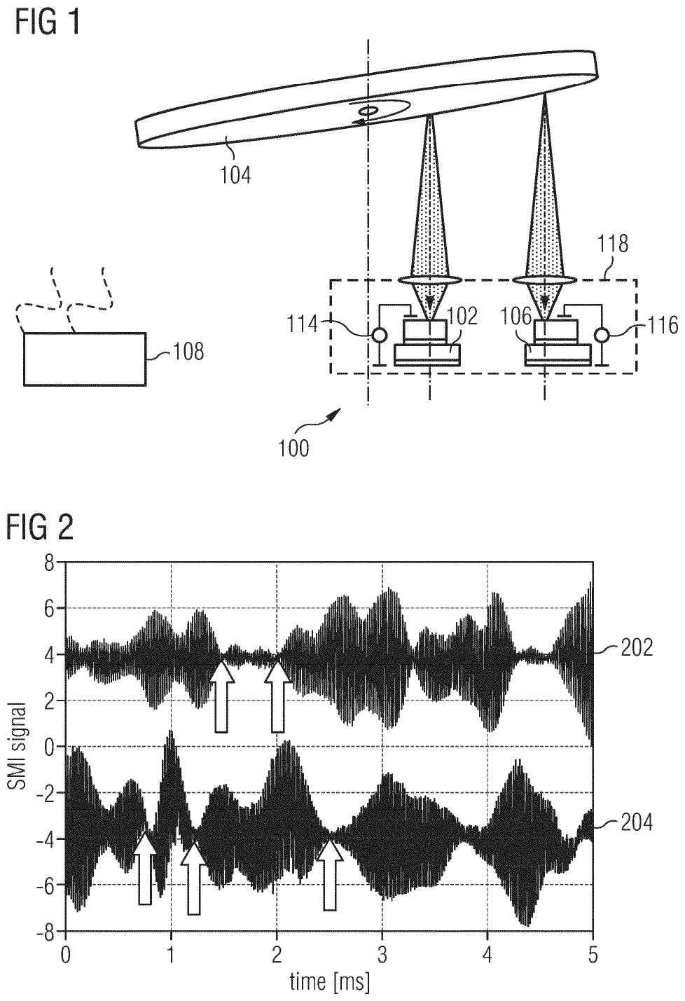

FIG. 1 depicts an SMI detection device 100, including a first electromagnetic radiation device 102, configured to emit first electromagnetic radiation toward a target 104 at a first time period, to receive a reflection of the first electromagnetic radiation from the target 104 emitted at the first time period, and to modulate first electromagnetic radiation emitted at a second time period by the received reflection of the first electromagnetic radiation. The SMI detection device 100 further includes a second electromagnetic radiation device 106, configured to emit second electromagnetic radiation toward the target 104 at the first time period, to receive a reflection of the second electromagnetic radiation from the target 104 emitted at the first time period, and to modulate second electromagnetic radiation emitted at a second time period by the received reflection of the second electromagnetic radiation. The second electromagnetic radiation device 106 is a predetermined (e.g. known) distance from the first electromagnetic radiation device 102. The SMI device 100 may further include a processor 108, configured to determine a rotational movement of the target based on at least a first electrical signal (not depicted) representing the modulated first electromagnetic radiation, a second electrical signal (not depicted) representing the modulated second electromagnetic radiation, and the predetermined distance. The first electromagnetic radiation device 102 and the second electromagnetic radiation device 106 may each be configured as vertical cavity surface emitting lasers (VCSEL).

The SMI device may include a die 118, wherein the first electromagnetic radiation device and the second electromagnetic radiation device are each disposed on or in the die at the predetermined distance. Various known techniques for fashioning electromagnetic radiation sources (e.g. VCSELs) on a die are known, and any such technique may be used. In some manufacturing processes, a very high degree of precision may be achieved, such that the distance between the two electromagnetic radiation sources (and therefore a distance between the places on the rotating target onto which the electromagnetic radiation of the two electromagnetic radiation sources is directed) may be determined within a very small tolerance. Although the predetermined distance may be selected for a given implementation and/or based on manufacturing techniques and allowances, the predetermined distance may optionally be between 50 μm and 0.5 mm. The predetermined distance may optionally be less than 0.1 mm. The predetermined distance may optionally be between 50 μm and 0.1 mm.

The SMI device 100 includes a first sensor 114, configured to generate the first electrical signal. The SMI device 100 includes a second sensor, configured to generate the second electrical signal 204. The first sensor 114 may be a voltage sensor (e.g. such as where the electromagnetic radiation device is driven with a constant current) that is configured to detect a voltage variation, relative to a first reference voltage, at a PN-junction of the first electromagnetic radiation device. In this manner, the second sensor 116 may also be a voltage sensor, configured to detect a voltage variation, relative to a second reference voltage, at a PN-junction of the second electromagnetic radiation device. In this configuration, the first sensor 114 is electrically connected to the first electromagnetic radiation device 102, and the second sensor 116 is electrically connected to the second electromagnetic radiation device 106.

In an alternate configuration, the first sensor 114 may be a current sensor (e.g. such as where the electromagnetic radiation device is driven with a constant voltage) that is configured to detect a current variation at the PN-junction of the first electromagnetic radiation device 102 (e.g. such as when the electromagnetic generation source is driven with a constant voltage). Similarly, the second sensor 116 may be a current sensor that is configured to detect a current variation at a PN-junction of the second electromagnetic radiation device 106.

In a further alternate configuration, the first sensor 114 may be a photodiode that is configured to detect electromagnetic radiation within the first electromagnetic radiation device 102, wherein the detected electromagnetic radiation includes an output of the first electromagnetic radiation device 102 and the reflection of the first electromagnetic radiation. Similarly, the second sensor may be a photodiode that is configured to detect electromagnetic radiation within the second electromagnetic radiation device 106. In this manner, the detected electromagnetic radiation includes an output of the second electromagnetic radiation device and the reflection of the second electromagnetic radiation.

The processor 108 may be configured to determine a rotational movement of the target 104 from the first electrical signal and the second electrical signal, as will be described in greater detail. The processor is may be configured to determine the rotational movement based on the SMI signal generated from the reflected first electromagnetic radiation, the SMI signal generated from the second electromagnetic radiation, and a distance between the first electromagnetic radiation device and the second electromagnetic radiation device. The processor 108 may be configured to determine the rotational movement of the target as a rotational velocity of one or more points of the target, an angular velocity, a rotational acceleration, an angular acceleration, or any of these.

FIG. 2 depicts the avoidance of signal loss due to dark speckle using multiple SMI signals. In this figure, a first SMI signal 202 and a second SMI signal 204 are depicted. As stated above, rotation of a target may generally be detected from an SMI signal utilizing either a fast Fourier transformation (FFT) (e.g. or otherwise transforming the signal, which is detected in the time domain, to the frequency domain) of the signal, or by counting signal peaks (e.g. “fringes”) in the time domain, from which the frequency can be calculated. Counting of fringes may often be preferable, as the FFT is computationally demanding and may require more robust processors, greater power resources, or the like. In the time domain, however, the detected signal is modulated by speckle.

To demonstrate, each signal of the first SMI signal 202 and the second SMI signal 204 includes varying amplitudes, due at least to bright speckle and dark speckle. As described above, speckle (e.g. bright speckle and dark speckle) results at least from roughness in a surface of the target from which the first electromagnetic radiation and the second electromagnetic radiation is reflected. Areas of larger amplitudes may correspond to bright speckle, whereas areas of small amplitudes may correspond to dark speckle. In this figure, each of the first SMI signal 202 and the second SMI signal 204 depicts a signal envelope, whose amplitude at certain points approaches or is equal to zero. These points are marked for convenience with a solid arrow. These points as marked by the solid arrow correspond to dark speckle.

In dark speckle, little or none of the generated electromagnetic radiation is reflected from the target 104 back to either the first electromagnetic radiation device 102 or the second electromagnetic radiation device 106, which results in a corresponding reduction of amplitude (e.g. of the first SMI signal 202, of the second SMI signal 204) and therefore difficulty in detecting rotation from that signal. Because, however, the first SMI signal 202 and the second SMI signal 204 are generated from reflections from different points of the target 104, it is extremely unlikely that dark speckle will simultaneously occur (e.g. be seen, manifest) in the first SMI signal 202 and the second SMI signal 204. In this manner, at least one of the first SMI signal 202 or the second SMI signal 204 is very likely to indicate data from which rotation of the target 104 may be detected. Accordingly, the processor may be configured to determine the rotational movement from only one of the two electromagnetic radiation devices (e.g. from only one SMI signal) if dark speckle temporarily prevents another SMI signal from being usable for this purpose.

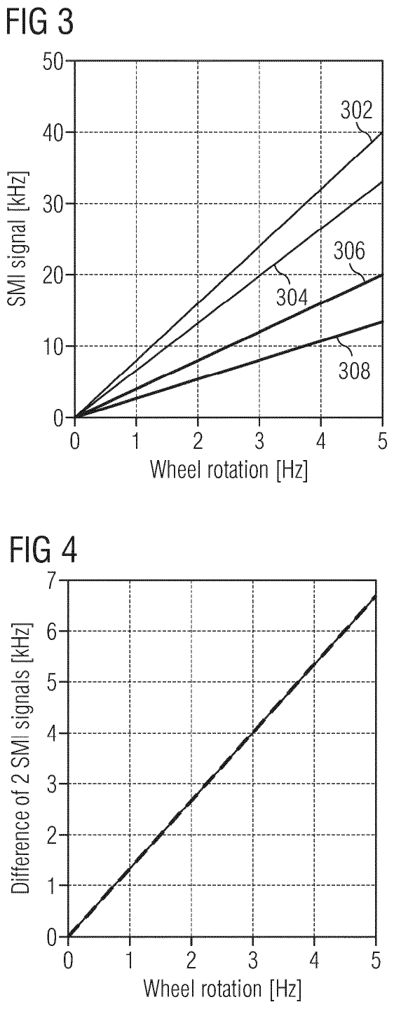

FIG. 3 depicts a frequency shift of the SMI signals according to an aspect of the disclosure. With respect to the first SMI signal 202 and the second SMI signal 204, each of these signals represents the electromagnetic radiation device power as modulated by the Doppler frequency, which is results from light reflected from the rotating target 104 as follows:

$${f}_{D} = 4 π {f}_{disk} R \frac{cos ( θ )}{λ} \qquad ( 1 )$$

wherein f_{D} is the frequency of the Doppler signal that modulates the laser output to result in f_{SMI}, f_{disk} is the rotational frequency of the target 104, R is the radius between the rotational center of the target and the point of the target onto which the electromagnetic radiation is directed (e.g. from where the electromagnetic radiation is reflected), θ is the tilt angle of the target relative to the beam of electromagnetic radiation, and Λ is the wavelength of the electromagnetic radiation. In other words, assuming a non-zero tilt-angle θ (e.g. assuming that the path of the electromagnetic radiation is non-normal to the surface of the rotating target), the target surface onto which the electromagnetic radiation is directed is instantaneously moving toward or moving away from the electromagnetic radiation source, which results in a Doppler-shift of the reflected electromagnetic radiation. Assuming the reflected electromagnetic radiation is electromagnetic radiation that was generated at a first time period, this reflected electromagnetic radiation re-enters the electromagnetic radiation source and is coherently combined with/e.g. modulates) electromagnetic radiation generated at a second time period. The electromagnetic radiation of the second time period and the phase-shifted (e.g. due to Doppler shift) electromagnetic radiation of the first time period are reflected in the SMI signal, which may be modulated in both frequency and amplitude. The rotational movement of the target may be detected from the SMI signal if the radius R is known. If R is unknown and thus omitted from Formula (1), above, the instantaneous velocity of the point of reflection is determined.

The instantaneous velocity of a particular point of the target from where the electromagnetic radiation is reflected, however, may be of less interest than the target's angular velocity or of a rotational velocity of another portion, such as point on the target's circumference. Converting between the instantaneous velocity of the particular point to the angular velocity (or even to a point on the edge) requires knowledge of the radius R or distance between the point for which the instantaneous velocity is known and the rotational center of the target. This radius R may be unknown or subject to manufacturing tolerances that lead to error.

In a conventional configuration, and due to the unknown or error-prone value of r, the sensor must be calibrated to match the f_{SMI} to the f_{disk}. That is, without calibration, the measurement of rotational velocity depends on the radius r, and small errors in measurement of r will result in errors according to:

$$Error ( \% ) = \frac{Δ R}{R} \qquad ( 2 )$$

It is very difficult to ensure highly-accurate placement of the electromagnetic radiation devices relative to the target such that knowledge of r is reliable. Thus, the SMI sensors must typically be calibrated to correct for any errors in placement (e.g. ΔR).

The need for calibration can be obviated where two electromagnetic radiation devices are used, in which a distance between the two electromagnetic radiation devices is known. That is, configuring the electromagnetic radiation devices to direct electromagnetic radiation to two specific and predetermined points of the disk may be difficult; however, because the two electromagnetic radiation devices may be manufactured on a common die, they may be manufactured a known distance from one another, subject to manufacturing tolerances. These manufacturing tolerances may easily be within the micrometer range. With knowledge of the frequency shift between the two signals and the distance between the two electromagnetic radiation devices, the rotational frequency of the target may be determined. Of note, this does not require the additional calibration that is otherwise necessary in a conventional device. Thus, the determination of the difference of the shifted frequencies (e.g., rather than relying on the frequency itself), and in light of a known distance between the two electromagnetic radiation devices, the calibration to match the f_{SMI} to the f_{disk} is no longer necessary.

This can be shown by considering formula (1) above, such that:

$${f}_{D 1} = 4 π {f}_{disk} {R}_{1} ( \frac{cos ( θ )}{λ} ) \qquad ( 3 )$$

$${f}_{D 2} = 4 π {f}_{disk} {R}_{2} ( \frac{cos ( θ )}{λ} ) \qquad ( 4 )$$

It follows that, if two electromagnetic radiation devices are used to create two different SMI signals, then:

$$Δ {f}_{SMI} = {f}_{SMI 1} - {f}_{SMI 2} = {f}_{D 1} - {f}_{D 2} = \frac{4 π {f}_{disk} cos ( θ )}{λ} ( {R}_{1} - {R}_{2} ) \qquad ( 5 )$$

Thus, by determining the frequency of the f_{SMI} signals, subtracting these frequencies, and given the known distance between R₁ and R₂ (e.g. such as based on their positions on a common die), the frequency of the target, and therefore the angular velocity of the target can be determined. That is, using a Fast Fourier Transform to transform the SMI signals into the frequency domain and selecting the primary frequency, or by counting the fringe to determine the frequency in the time domain, the frequencies of the SMI signals can be determined, and the rotational movement of the target can then be derived using Formula 5.

The fringe counting method may generally involve counting a number of “fringes” (e.g. amplitude crests) in a predetermined duration of time, from which the frequency may be calculated. In this manner, the processor may be configured to receive the first SMI signal and/or the second SMI signal any to count in either or both of these signals a number of electrical signal peaks, in which the electrical signal rises above a predetermined threshold. That is, the processor may be configured to determine a number of first electrical signal peaks, in which the first SMI signal rises above a predetermined threshold and/or a number of second electrical signal peaks, in which the second SMI signal rises above the predetermined threshold.

The above procedure may be further demonstrated by way of FIGS. 3 and 4, which depict rotational frequency and light of SMI signals and their differences. In FIG. 3, a first SMI readout 302 for a first electromagnetic radiation device correlating rotational frequency to SMI signal (kHz); a second SMI readout 304 for a second electromagnetic radiation device correlating rotational frequency to SMI signal (kHz); a third SMI readout 306 for a third electromagnetic radiation device correlating rotational frequency to SMI signal (kHz); and a fourth SMI readout 308 for a fourth electromagnetic radiation device correlating rotational frequency to SMI signal (kHz) are depicted. The first and the second magnetic radiation devices are paired with a known distance of 0.1 mm between them, and the third and the fourth electromagnetic radiation devices are paired with a known distance of 0.1 mm between them. FIG. 4 depicts a difference between the first SMI readout 302 and the second SMI readout 304, in between the third SMI readout 306 and the fourth SMI readout 308. As depicted in this figure, the differences between these pairs of readouts are identical. Otherwise stated, because the distance between the electromagnetic radiation device corresponding to the first SMI readout 302 and the electromagnetic radiation device corresponding to the second SMI readout 304 is equal to the distance between the electromagnetic radiation device corresponding to the third SMI readout 306 and the electromagnetic radiation device corresponding to the fourth SMI readout 308, the differences of signals for each of these 2 groups (difference of signals in Hertz relative to rotation) are identical.

It is noted that the procedures for determining the rotational frequency of the target based on a difference (e.g., subtraction) of the SMI signals, as disclosed above, may in some circumstances alternatively be performed based on an addition of SMI signals. This configuration requires that the axis of rotation be between a place on the target onto which the first electromagnetic radiation is directed and a place on the target onto which the second electromagnetic radiation is directed. In this manner, any error in favor of one direction (e.g. again in one direction) will be compensated for by a loss in the other direction. Nevertheless, this may significantly reduce (e.g. such as by half) the phase shift, which may require additional measures to accurately detect rotational speed, such as e.g. higher FFT resolution.

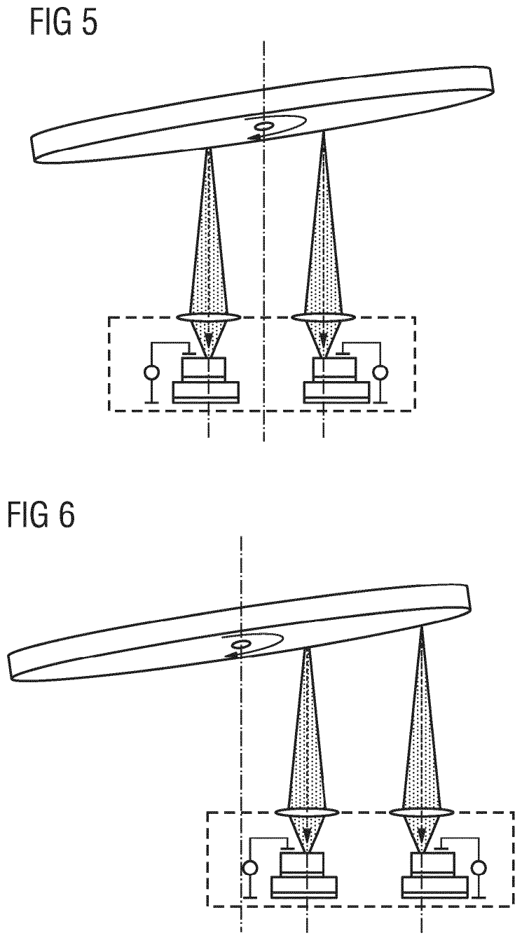

Various configurations of the first electromagnetic radiation device and the second electromagnetic radiation device relative to the axis of rotation are conceivable. FIG. 5 depicts a configuration of the electromagnetic radiation devices relative to the axis of rotation of a (tilted) disk, according to a first aspect of the disclosure. In this configuration, the axis of rotation is between an area of the disk onto which the first electromagnetic radiation is directed and an area of the disk onto which the second electromagnetic radiation is directed. As described above, the detected phase shifts in this configuration may be added or subtracted.

FIG. 6 depicts a configuration of the electromagnetic radiation devices relative to the axis of rotation of the (tilted) disk, according to a second aspect of the disclosure. In this configuration, each of the first electromagnetic radiation device and the second electromagnetic radiation device direct electromagnetic radiation onto the same half of the disk. Otherwise stated, and axis of rotation is not between an area onto which the first electromagnetic radiation device directs electromagnetic radiation and an area onto which the second electromagnetic radiation device directs electromagnetic radiation. In this configuration, the rotational frequency may be determined based on a known distance between the first electromagnetic radiation device and the second electromagnetic radiation device, and a difference between the first SMI signal and the second SMI signal.

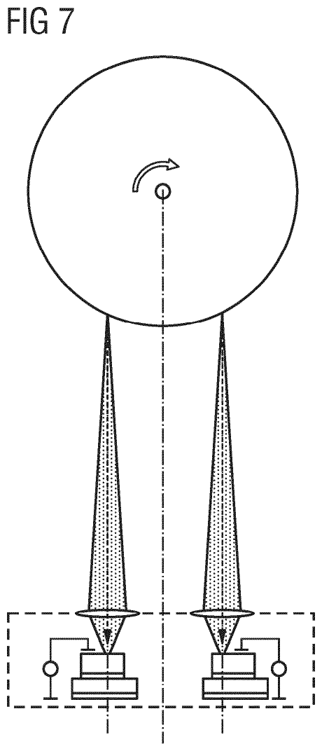

FIG. 7 depicts a configuration of the electromagnetic radiation devices relative to a rotating shaft according to a third aspect of the disclosure. In this configuration, each of the electromagnetic radiation devices directs electromagnetic radiation onto a different half of the rotating shaft. Otherwise stated, a rotational access of the shaft is between the path on which the first electromagnetic radiation device directs electromagnetic radiation and the path on which the second electromagnetic radiation device directs electromagnetic radiation. Using this configuration, the rotational velocity of the shaft may be determined based on a difference between the phase shift of the signals and a known distance between the first electromagnetic radiation device and the second electromagnetic radiation device.

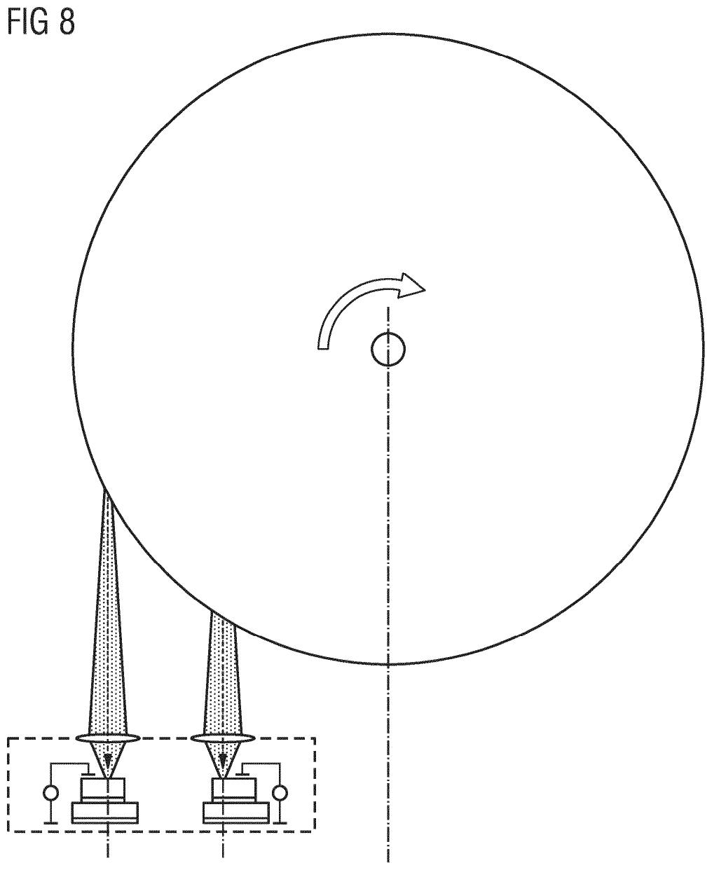

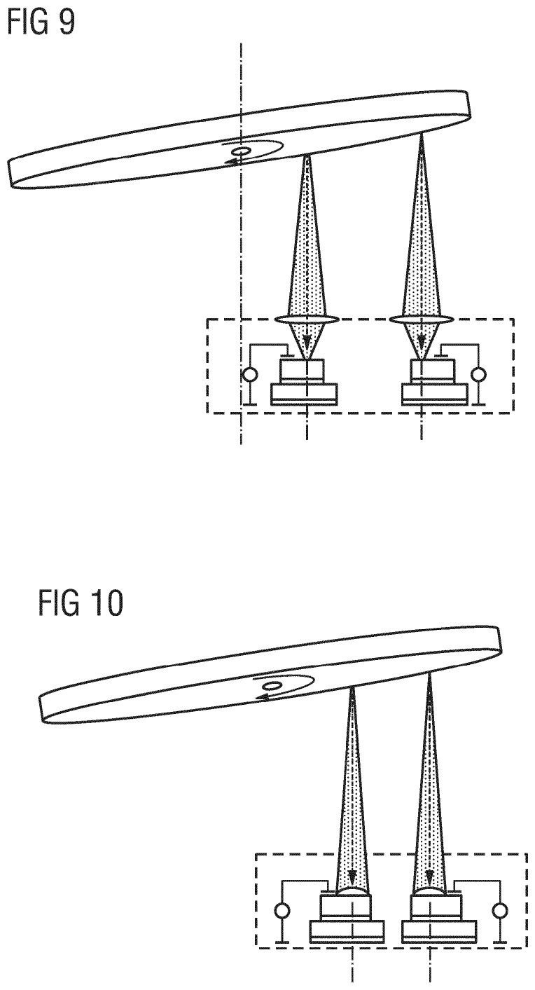

FIG. 8 depicts a configuration of the electromagnetic radiation devices relative to a rotating shaft according to a fourth aspect of the disclosure. In this configuration, both electromagnetic radiation devices direct electromagnetic radiation onto the same half of the rotating shaft. Otherwise stated, a rotational axis of the shaft is not between the path on which the first electromagnetic radiation device directs electromagnetic radiation and the path on which the second electromagnetic radiation device directs electromagnetic radiation. Using this configuration, the rotational velocity of the shaft may be determined based on a sum or a difference between the SMI signals and a known distance between the first electromagnetic radiation device and the second electromagnetic radiation device.

The electromagnetic radiation devices may be manufactured according to any of a plurality of procedures, which may yield various tolerances and thus varying levels of accuracy. FIG. 9 depicts a package assembly according to an aspect of the disclosure. In this package assembly, each of the first electromagnetic radiation device, the second electromagnetic radiation device, a first lens, and a second lens, are placed during the manufacturing process. The ultimate accuracy of the rotational velocity of the target will depend on the tolerances of the assembly, such as a tolerance for placement of the first electromagnetic radiation device and the second electromagnetic radiation device, and a tolerance for positioning of the respective lenses.

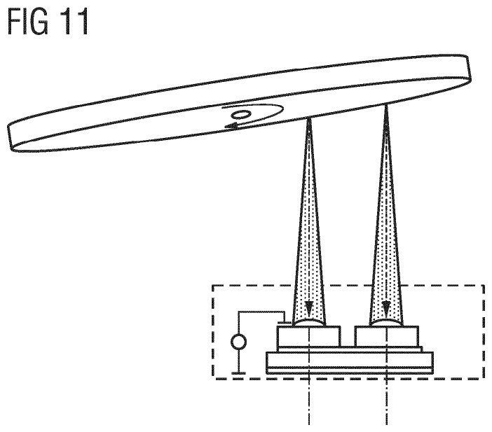

FIG. 10 depicts a package assembly according to another aspect of the disclosure. According to this aspect, each of the two lenses may be back side integrated onto separate dies. In this manner, the accuracy of the rotational velocity will depend on the tolerances of the positioning of the first electromagnetic radiation device relative to the second electromagnetic radiation device. In some manufacturing processes, this tolerance may be approximately ±20 μm.

FIG. 11 depicts a package assembly according to yet another aspect of the disclosure. According to this aspect, the lenses may be back side integrated on a single die. In this manner, the accuracy of the rotational velocity measurements will depend only on the lithography tolerances of the given lens with respect to its corresponding electromagnetic radiation device. In some manufacturing processes, this tolerance may be approximately ±2 μm.

In some configurations, the target may be configured to rotate about a first axis, wherein the first electromagnetic radiation device is configured to direct the first electromagnetic radiation along a second axis that is off-axis (e.g. non-parallel) with respect to the first axis. The second electromagnetic radiation device is configured to direct the second electromagnetic radiation along a third axis that is parallel to the second axis.

The first electromagnetic radiation device and the second electromagnetic radiation device may be positioned relative to the target such that upon rotation of the target, electromagnetic radiation reflected from the rotating target is reflected with a Doppler shift corresponding to an angle of incidence between the electromagnetic radiation and the rotating target, and a rotational velocity of the target.

The processor may be further configured, when either an amplitude of the first electrical signal or an amplitude of the second electrical signal falls beneath a predetermined threshold, to determine the rotational movement of the target based on the other of the first electrical signal or the second electrical signal. This may be achieved, for example, by temporarily relying on a stored radius value for the SMI signal used to determine the rotational velocity.

According to an aspect of the disclosure, the first electromagnetic radiation device may be configured to emit electromagnetic radiation onto a region of the target having a first radius relative to the longitudinal axis; wherein the second electromagnetic radiation device is configured to emit electromagnetic radiation onto a region of the target having a second radius relative to the longitudinal axis; further including a third electromagnetic radiation device, configured to emit third electromagnetic radiation onto a region of the target having a third radius relative to the longitudinal axis and to receive a reflection of the third electromagnetic radiation from the target; wherein the first radius and the third radius are equal to one another.

In this manner, the device may further include a third sensor, connected to the third electromagnetic radiation device, and configured to generate a third electrical signal representing an output of the third electromagnetic radiation device as modulated by the reflection of the third electromagnetic radiation; wherein the processor is configured to determine a first rotational frequency of the target based on the first electrical signal, and a third rotational frequency of the target based on the third signal, and if the first rotational frequency and the third rotational frequency are different from each other, to resolve a difference between the first rotational frequency and the third rotational frequency as a tilt of the target.

Additional aspects of the disclosure will be disclosed by way of example.

In Example 1, a detection device, including:
a first electromagnetic radiation device, configured to emit first electromagnetic radiation toward a target at a first time period, to receive a reflection of the first electromagnetic radiation from the target emitted at the first time period, and to modulate first electromagnetic radiation emitted at a second time period by the received reflection of the first electromagnetic radiation; a second electromagnetic radiation device, configured to emit second electromagnetic radiation toward a target at the first time period, to receive a reflection of the second electromagnetic radiation from the target emitted at the first time period, and to modulate second electromagnetic radiation emitted at a second time period by the received reflection of the second electromagnetic radiation, wherein the second electromagnetic radiation device is a predetermined distance from the first electromagnetic radiation device; a processor, configured to determine a rotational movement of the target based on a first electrical signal representing the modulated first electromagnetic radiation, a second electrical signal representing the modulated second electromagnetic radiation, and the predetermined distance.

In Example 2, the detection device of Example 1, wherein the first electromagnetic radiation device and the second electromagnetic radiation device are each vertical cavity surface emitting lasers.

In Example 3, the detection device of Example 1 or 2, further including a die, wherein the first electromagnetic radiation device and the second electromagnetic radiation device are each disposed on or in the die at the predetermined distance.

In Example 4, the detection device of Example 3, wherein the predetermined distance is 50 μm to 0.5 mm.

In Example 5, the detection device of any one of Examples 1 to 4, wherein the processor is configured to determine a first Doppler frequency of the target from the first electrical signal, and a second Doppler frequency of the target from the second electrical signal; wherein the rotational movement is a rotational frequency of the target; and wherein the processor is configured to determine the rotational frequency based on a difference between the first Doppler frequency and the second Doppler frequency, and the predetermined distance.

In Example 6, the detection device of any one of Examples 1 to 5, further including:
a first sensor, configured to generate the first electrical signal; and
a second sensor, configured to generate the second electrical signal.

In Example 7, the detection device of Example 6, wherein the first sensor is a voltage sensor, configured to detect a voltage variation, relative to a first reference voltage, at a PN-junction of the first electromagnetic radiation device; and wherein the second sensor is a voltage sensor, configured to detect a voltage variation, relative to a second reference voltage, at a PN-junction of the second electromagnetic radiation device.

In Example 8, the detection device of Example 6, wherein the first sensor is electrically connected to the first electromagnetic radiation device, and wherein the second sensor is electrically connected to the second electromagnetic radiation device.

In Example 9, the detection device of Example 6, wherein the first sensor is a current sensor, configured to detect a current variation at a PN-junction of the first electromagnetic radiation device; and wherein the second sensor is a current sensor, configured to detect a current variation at a PN-junction of the second electromagnetic radiation device.

In Example 10, the detection device of Example 6, wherein the first sensor is a photodiode, configured to detect electromagnetic radiation within the first electromagnetic radiation device, wherein the detected electromagnetic radiation includes an output of the first electromagnetic radiation device and the reflection of the first electromagnetic radiation; and wherein the second sensor is a photodiode, configured to detect electromagnetic radiation within the second electromagnetic radiation device, wherein the detected electromagnetic radiation includes an output of the second electromagnetic radiation device and the reflection of the second electromagnetic radiation.

In Example 11, the detection device of any one of Examples 1 to 10, wherein determining the rotational movement of the target includes determining a rotational velocity, a rotational distance, a rotational acceleration, a rotational position of the target, or any of these.

In Example 12, the detection device of any one of Examples 1 to 11, wherein determining the rotational movement of the target includes the processor determining a number of first electrical signal peaks, in which the first electrical signal rises above a predetermined threshold.

In Example 13, the detection device of any one of Examples 1 to 12, wherein determining the rotational movement of the target includes the processor determining a number of second electrical signal peaks, in which the second electrical signal rises above a predetermined threshold.

In Example 14, the detection device of any one of Examples 1 to 13, wherein determining the rotational movement of the target includes the processor transforming the first electrical signal and the second electrical signal from a time domain into a frequency domain.

In Example 15, the detection device of any one of Examples 1 to 14, wherein the target is configured to rotate about a first axis, wherein the first electromagnetic radiation device is configured to direct the first electromagnetic radiation along a second axis that is non-parallel to the first axis; wherein the second electromagnetic radiation device is configured to direct the first electromagnetic radiation along a third axis that is parallel to the second axis.

In Example 16, the detection device of Example 15, wherein the processor is further configured to determine the rotational movement of the target using an angle of the first axis and the longitudinal axis.

In Example 17, the detection device of any one of Examples 1 to 16, wherein the first electromagnetic radiation device and the second electromagnetic radiation device are positioned relative to the target such that upon rotation of the target, electromagnetic radiation reflects from the target is reflected with a phase shift corresponding to an angle of incident to the target and rotational velocity of the target.

In Example 18, the detection device of any one of Examples 1 to 17, wherein the first electromagnetic radiation device is configured to direct first electromagnetic radiation toward the target along a first axis; wherein the second electromagnetic radiation device is configured to direct second electromagnetic radiation toward the target along a second axis, and wherein a rotational axis of the target is between the first axis and the second axis.

In Example 19, the detection device of any one of Examples 1 to 17, wherein the first electromagnetic radiation device is configured to direct first electromagnetic radiation toward the target along a first axis; wherein the second electromagnetic radiation device is configured to direct second electromagnetic radiation toward the target along a second axis, and wherein a rotational axis of the target is not between the first axis and the second axis.

In Example 20, the detection device of any one of Examples 1 to 19, further including the target, wherein the target is configured to rotate about its longitudinal axis.

In Example 21, the detection device of any one of Examples 1 to 20, wherein the processor is further configured, when either a magnitude of the first electrical signal or a magnitude of the second electrical signal falls beneath a predetermined threshold, to determine the rotational movement of the target based on the other of the first electrical signal or the second electrical signal.

In Example 22, the detection device of any one of Examples 1 to 21, wherein the first electromagnetic radiation device is configured to emit electromagnetic radiation onto a region of the target having a first radius relative to the longitudinal axis; wherein the second electromagnetic radiation device is configured to emit electromagnetic radiation onto a region of the target having a second radius relative to the longitudinal axis; further including a third electromagnetic radiation device, configured to emit third electromagnetic radiation onto a region of the target having a third radius relative to the longitudinal axis and to receive a reflection of the third electromagnetic radiation from the target; wherein the first radius and the third radius are equal to one another.

In Example 23, the detection device of Example 22, further including a third sensor, connected to the third electromagnetic radiation device, and configured to generate a third electrical signal representing an output of the third electromagnetic radiation device as modulated by the reflection of the third electromagnetic radiation; wherein the processor is configured to determine a first rotational frequency of the target based on the first electrical signal, and a third rotational frequency of the target based on the third signal, and if the first rotational frequency and the third rotational frequency are different from each other, to resolve a difference between the first rotational frequency and the third rotational frequency as a tilt of the target.

In Example 24, a detection device, including: a processor, configured to: receive a first electrical signal representing a reflection of first electromagnetic radiation off of a target at a first time period, as modulated by first electromagnetic radiation emitted at a second time period; receive a second electrical signal representing a reflection of second electromagnetic radiation off of a target at the first time period, as modulated by second electromagnetic radiation emitted at a second time period; determine a rotational movement of the target based on the first electrical signal and the second electrical signal.

In Example 25, the detection device of Example 24, wherein the processor is configured to determine a first Doppler frequency of the target from the first electrical signal, and a second Doppler frequency of the target from the second electrical signal; wherein the rotational movement is a rotational frequency of the target; and wherein the processor is configured to determine the rotational frequency based on a difference between the first Doppler frequency and the second Doppler frequency, and a distance between a source of the first electromagnetic radiation and a source of the second electromagnetic radiation.

In Example 26, the detection device of Example 24 or 25, wherein determining the rotational movement of the target includes determining a rotational velocity, a rotational distance, a rotational acceleration, a rotational position of the target, or any of these.

In Example 27, the detection device of any one of Examples 24 to 26, wherein determining the rotational movement of the target includes the processor determining a number of first electrical signal peaks, in which the first electrical signal rises above a predetermined threshold.

In Example 28, the detection device of any one of Examples 24 to 27, wherein determining the rotational movement of the target includes the processor determining a number of second electrical signal peaks, in which the second electrical signal rises above a predetermined threshold.

In Example 29, the detection device of any one of Examples 24 to 28, wherein determining the rotational movement of the target includes the processor transforming the first electrical signal and the second electrical signal from a time domain into a frequency domain.

In Example 30, the detection device of any one of Examples 24 to 29, wherein the processor is further configured to determine the rotational movement of the target using an angle between path of the first electromagnetic radiation and a surface of the target and/or an angle between path of the second electromagnetic radiation and the surface of the target.

In Example 31, the detection device of any one of Examples 24 to 30, wherein the processor is further configured, when either a magnitude of the first electrical signal or a magnitude of the second electrical signal falls beneath a predetermined threshold, to determine the rotational movement of the target based on the other of the first electrical signal or the second electrical signal.

In Example 32, a non-transitory computer readable medium, including instructions which, if executed, cause one or more processors to: receive a first electrical signal representing a reflection of first electromagnetic radiation off of a target at a first time period, as modulated by first electromagnetic radiation emitted at a second time period; receive a second electrical signal representing a reflection of second electromagnetic radiation off of a target at the first time period, as modulated by second electromagnetic radiation emitted at a second time period; and determine a rotational movement of the target based on the first electrical signal and the second electrical signal.

In Example 33, the non-transitory computer readable medium of Example 32, wherein the instructions are further configured to cause the processor to determine a first Doppler frequency of the target from the first electrical signal, and a second Doppler frequency of the target from the second electrical signal; wherein the rotational movement is a rotational frequency of the target; and wherein the instructions are further configured to cause the processor to determine the rotational frequency based on a difference between the first Doppler frequency and the second Doppler frequency, and a distance between a source of the first electromagnetic radiation and a source of the second electromagnetic radiation.

In Example 34, the non-transitory computer readable medium of Example 32 or 33, wherein determining the rotational movement of the target includes the instructions being configured to cause the processor to determine a rotational velocity, a rotational distance, a rotational acceleration, a rotational position of the target, or any of these.

In Example 35, the non-transitory computer readable medium of any one of Examples 32 to 34, wherein the determining the rotational movement of the target includes the instructions being configured to cause the processor to determine a number of first electrical signal peaks, in which the first electrical signal rises above a predetermined threshold.

In Example 36, the non-transitory computer readable medium of any one of Examples 32 to 35, wherein determining the rotational movement of the target includes the instructions being configured to cause the processor to determine a number of second electrical signal peaks in which the second electrical signal rises above a predetermined threshold.

In Example 37, the non-transitory computer readable medium of any one of Examples 32 to 36, wherein determining the rotational movement of the target includes the instructions being configured to cause the processor to transform the first electrical signal and the second electrical signal from a time domain into a frequency domain.

In Example 38, the non-transitory computer readable medium of any one of Examples 32 to 37, wherein the instructions are further configured to cause the processor to determine the rotational movement of the target using an angle between path of the first electromagnetic radiation and a surface of the target and/or an angle between path of the second electromagnetic radiation and the surface of the target.

In Example 39, the non-transitory computer readable medium of any one of Examples 32 to 38, wherein the instructions are further configured to cause the processor, when either a magnitude of the first electrical signal or a magnitude of the second electrical signal falls beneath a predetermined threshold, to determine the rotational movement of the target based on the other of the first electrical signal or the second electrical signal.

In Example 40, a method of rotation detection, including receiving a first electrical signal representing a reflection of first electromagnetic radiation off of a target at a first time period, as modulated by first electromagnetic radiation emitted at a second time period; receiving a second electrical signal representing a reflection of second electromagnetic radiation off of a target at the first time period, as modulated by second electromagnetic radiation emitted at a second time period; and determining a rotational movement of the target based on the first electrical signal and the second electrical signal.

In Example 41, the method of rotation detection of Example 40, further including determining a first Doppler frequency of the target from the first electrical signal, and a second Doppler frequency of the target from the second electrical signal; wherein the rotational movement is a rotational frequency of the target; and further including determining the rotational frequency based on a difference between the first Doppler frequency and the second Doppler frequency, and a distance between a source of the first electromagnetic radiation and a source of the second electromagnetic radiation.

In Example 42, the detection device of Example 40 or 41, wherein determining the rotational movement of the target includes determining a rotational velocity, a rotational distance, a rotational acceleration, a rotational position of the target, or any of these.

In Example 43, the detection device of any one of Examples 40 to 42, wherein determining the rotational movement of the target includes the processor determining a number of first electrical signal peaks, in which the first electrical signal rises above a predetermined threshold.

In Example 44, the detection device of any one of Examples 40 to 43, wherein determining the rotational movement of the target includes the processor determining a number of second electrical signal peaks, in which the second electrical signal rises above a predetermined threshold.

In Example 45, the detection device of any one of Examples 40 to 44, wherein determining the rotational movement of the target includes transforming the first electrical signal and the second electrical signal from a time domain into a frequency domain.

In Example 46, the detection device of any one of Examples 40 to 45, further including determining the rotational movement of the target using an angle between path of the first electromagnetic radiation and a surface of the target and/or an angle between path of the second electromagnetic radiation and the surface of the target.

In Example 47, the detection device of any one of Examples 40 to 46, further including, when either a magnitude of the first electrical signal or a magnitude of the second electrical signal falls beneath a predetermined threshold, determining the rotational movement of the target based on the other of the first electrical signal or the second electrical signal.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

### LIST OF REFERENCE NUMBERS

100 detection device
102 first electromagnetic radiation device
104 target
106 second electromagnetic radiation device
108 processor
114 first sensor
116 second sensor
118 die
202 first electrical signal/first SMI signal
204 second electrical signal/second SMI signal
302 first SMI readout
304 second SMI readout
306 third SMI readout
308 fourth SMI readout

1. A detection device, comprising:
a first electromagnetic radiation device, configured to emit first electromagnetic radiation toward a target at a first time period, to receive a reflection of the first electromagnetic radiation from the target emitted at the first time period, and to modulate first electromagnetic radiation emitted at a second time period by the received reflection of the first electromagnetic radiation;
a second electromagnetic radiation device, configured to emit second electromagnetic radiation toward a target at the first time period, to receive a reflection of the second electromagnetic radiation from the target emitted at the first time period, and to modulate second electromagnetic radiation emitted at a second time period by the received reflection of the second electromagnetic radiation, wherein the second electromagnetic radiation device is a predetermined distance from the first electromagnetic radiation device; and
a processor, configured to determine an angular velocity of the target based on a first electrical signal representing the modulated first electromagnetic radiation, a second electrical signal representing the modulated second electromagnetic radiation, and the predetermined distance.

2. The detection device of claim 1, wherein the first electromagnetic radiation device and the second electromagnetic radiation device are each vertical cavity surface emitting lasers.

3. The detection device of claim 1, further comprising a die, wherein the first electromagnetic radiation device and the second electromagnetic radiation device are each disposed on or in the die at the predetermined distance.

4. The detection device of claim 1, wherein the processor is configured to determine a first phase shift of the target from the first electrical signal, and a second phase shift of the target from the second electrical signal; wherein the processor is configured to determine the angular velocity based on a difference between the first phase shift and the second phase shift, and the predetermined distance.

5. The detection device of claim 1, further comprising:
a first sensor, configured to generate the first electrical signal; and
a second sensor, configured to generate the second electrical signal.

6. The detection device of claim 5, wherein the first sensor is a voltage sensor, configured to detect a voltage variation, relative to a first reference voltage, at a PN-junction of the first electromagnetic radiation device; and wherein the second sensor is a voltage sensor, configured to detect a voltage variation, relative to a second reference voltage, at a PN-junction of the second electromagnetic radiation device; or
wherein the first sensor is a current sensor, configured to detect a current variation at a PN-junction of the first electromagnetic radiation device; and wherein the second sensor is a current sensor, configured to detect a current variation at a PN-junction of the second electromagnetic radiation device; or
wherein the first sensor is a photodiode, configured to detect electromagnetic radiation within the first electromagnetic radiation device, wherein the detected electromagnetic radiation comprises an output of the first electromagnetic radiation device and the reflection of the first electromagnetic radiation; and wherein the second sensor is a photodiode, configured to detect electromagnetic radiation within the second electromagnetic radiation device, wherein the detected electromagnetic radiation comprises an output of the second electromagnetic radiation device and the reflection of the second electromagnetic radiation.

7. The detection device of claim 1, wherein determining the angular velocity of the target comprises determining an angular velocity, a rotational velocity, an angular acceleration, a rotational acceleration, or any of these.

8. The detection device of claim 1, wherein determining the angular velocity of the target comprises the processor determining a number of first electrical signal peaks, in which the first electrical signal rises above a predetermined threshold.

9. The detection device of claim 1, wherein determining the angular velocity of the target comprises the processor determining a number of second electrical signal peaks, in which the second electrical signal rises above a predetermined threshold.

10. The detection device of claim 1, wherein determining the angular velocity of the target comprises the processor transforming the first electrical signal and the second electrical signal from a time domain into a frequency domain.

11. The detection device of claim 1, wherein the target is configured to rotate about a first axis, wherein the first electromagnetic radiation device is configured to direct the first electromagnetic radiation along a second axis that is non-parallel to the first axis; wherein the second electromagnetic radiation device is configured to direct the first electromagnetic radiation along a third axis that is parallel to the second axis.

12. The detection device of claim 11, wherein the processor is further configured to determine the angular velocity of the target using an angle of the first axis relative to the second axis or the third axis.

13. The detection device of claim 1, wherein the first electromagnetic radiation device is configured to direct first electromagnetic radiation toward the target along a first axis; wherein the second electromagnetic radiation device is configured to direct second electromagnetic radiation toward the target along a second axis, and wherein a rotational axis of the target is between the first axis and the second axis.

14. The detection device of claim 1, wherein the first electromagnetic radiation device is configured to direct first electromagnetic radiation toward the target along a first axis; wherein the second electromagnetic radiation device is configured to direct second electromagnetic radiation toward the target along a second axis, and wherein a rotational axis of the target is not between the first axis and the second axis.

15. The detection device of claim 1, wherein the processor is further configured, when either an amplitude of the first electrical signal or an amplitude of the second electrical signal falls beneath a predetermined threshold, to determine the angular velocity of the target based on the other of the first electrical signal or the second electrical signal.

16. A non-transitory computer readable medium, comprising instructions which, if executed, cause one or more processors to:
receive a first electrical signal representing a reflection of first electromagnetic radiation off of a target at a first time period, as modulated by first electromagnetic radiation emitted at a second time period;
receive a second electrical signal representing a reflection of second electromagnetic radiation off of a target at the first time period, as modulated by second electromagnetic radiation emitted at a second time period; and
determine an angular velocity of the target based on the first electrical signal and the second electrical signal.

17. A method of rotation detection, comprising:
receiving a first electrical signal representing a reflection of first electromagnetic radiation off of a target at a first time period, as modulated by first electromagnetic radiation emitted at a second time period;
receiving a second electrical signal representing a reflection of second electromagnetic radiation off of a target at the first time period, as modulated by second electromagnetic radiation emitted at a second time period; and
determining an angular velocity.
